(19) United States
(12) Patent Application Publication
(10) Pub. No.: US 2002/0055602 A1
(43) Pub. Date: May 9, 2002

(54) Aromatic polyisocyanates blocked by pyrazole or pyrazole derivatives and the preparation and use thereof

(76) Inventors: Michael Gerle, Bergheim (DE); Hans-Albert Ehlert, Singapore (SG); Eberhard Konig, Leverkusen (DE)

Correspondence Address: BAYER CORPORATION, PATENT DEPARTMENT, 100 BAYER ROAD, PITTSBURGH, PA, 15205, US

(21) Appl. No.: 09/942,465

(22) Filed: Aug. 29, 2001

(30) Foreign Application Priority Data
Aug. 31, 2000 (DE) 10042738.3

(51) Int. Cl. C08G 18/80

(52) U.S. Cl. 528/45

(57) ABSTRACT

This invention relates to NCO-containing reaction products blocked at the NCO groups by 1-H-pyrazole or derivatives thereof, wherein the NCO-containing reaction products are reaction products of

(A) one or more aromatic polyisocyanates,

(B) one or more NCO-reactive compounds containing sulfonate and/or tert-amino groups, and

(C) optionally, one or more further NCO-reactive compounds other than compounds (B),

which are useful for treating substrates, especially textiles, paper, or leather.

### BACKGROUND OF THE INVENTION

The invention relates to aromatic polyisocyanates blocked by pyrazole or pyrazole derivatives, processes for their preparation, and their use for treating textiles, paper, or leather.

Isocyanates that have been modified with ionic groups or polyalkylene oxide units, and hence are hydrophilic, are dispersible in water but have only a limited stability in aqueous media because of the reactivity of the isocyanate group. For instance, WO-A-99/10590 describes such products, said to be suitable for the antifelt finishing of wool, that have a maximum dispersion stability of 24 hours.

However, blocking isocyanate groups with blocking agents as described, for example, in Houben-Weyl, Methoden der organischen Chemie, Volume E 20, pages 1617-19 and 1650-51, G. Thieme Verlag Stuttgart, 1987 or in Ullmann's Encyclopedia of Industrial Chemistry, Fifth Edition, Vol. A 21, page 674, VCH, 1992, provides stable dispersions upon addition of water. Products of this type are frequently used as a binder component for coating metals, wood, paper, leather and plastics.

EP-A 537,578 discloses the use of such hydrophilicized blocked isocyanates for finishing textiles. U.S. Pat. No. 4,834,764 describes treating textiles with a combination of specific hydrophilicized blocked isocyanates with perfluoroalkyl-containing polymers.

DE-A-44 33 437 discloses using specific blocked isocyanates as a crosslinker of print pastes used in textile printing.

Economic considerations dictate that the blocking group used should be redetachable from the blocked isocyanates at very low temperatures in the applications described. This is actually absolutely essential for substrates that lack thermal stability, such as wool.

Blocked products having low deblocking temperatures, however, frequently possess inadequate storage stability in the form of their aqueous dispersions.

U.S. Pat. No. 4,008,247, GB-A-2,153,346, U.S. Pat. No. 4,623,731, and EP-A 500,495 describe the use of certain pyrazole derivatives as blocking agents. EP-A 159,117 utilizes polyisocyanates blocked by pyrazole derivatives as an ingredient of paint formulations. WO-A-97/12924 and EP-A 942,023 disclose polyisocyanates that are blocked by pyrazole derivatives and that are hydrophilicized by incorporated ethylene oxide groups or hydroxycarboxylic acids.

However, such products are not suitable for textile applications as described in EP-A 537,578 or U.S. Pat. No. 4,834,764, since the amount of incorporated ethylene oxide groups that is necessary for hydrophilicization leads to permanent hydrophilicity and hence to an inadequate hydrophobicizing effect of the textile finish. A further disadvantage is the ease of removal of such hydrophilic products by washing. Also, the use of incorporable hydroxycarboxylic acids for hydrophilicizing blocked isocyanates provides products that cannot be used for textile applications, since they are not sufficiently compatible with other formulation ingredients. For instance, the finishing liquors may frequently also have to include methylolated urea or melamine derivatives, which are only adequately effective in the acidic pH range. Similarly, other widely used liquor components, for example, flame retardants, or aminosilicone emulsions used as softeners, frequently require that the liquor be adjusted to an acidic pH. However, polyisocyanates hydrophilicized with carboxyl groups are not stable in acids because of the relatively high pKa value of carboxylic acids and consequently lead to precipitates.

Prior art products are further disadvantageous in that they are usually inconvenient to produce. It is frequently necessary to use large amounts of external emulsifiers and high shearing forces to disperse the blocked polyisocyanates. In the case of products hydrophilicized using incorporable ionic groups, the isocyanate groups are so sensitive that frequently it is necessary to use a two-step process whereby the isocyanate is blocked in the first step and the ionic groups are only incorporated subsequently.

It is a further object of the present invention to provide in a simple way novel hydrophilicized blocked polyisocyanates that combine high reactivity and good stability in water. The products shall also couple very low hydrophilicity with good water dispersibility and stability of the dispersion to acids.

### SUMMARY OF THE INVENTION

The invention accordingly provides NCO-containing reaction products blocked at the NCO groups by 1-H-pyrazole or derivatives thereof, wherein the NCO-containing reaction products are reaction products of

(A) one or more aromatic polyisocyanates,

(B) one or more NCO-reactive compounds containing sulfonate and/or tert-amino groups, and

(C) optionally, one or more further NCO-reactive compounds other than compounds (B).

### DETAILED DESCRIPTION OF THE INVENTION

Useful polyisocyanates for component (A) are any aromatic polyisocyanates or mixtures thereof that have an average molecular weight, determined from isocyanate content and functionality, of 150 to 5000, preferably 500 to 2000 g/mol. Suitable are the isocyanates known per se from polyurethane chemistry such as the isomeric diphenylmethane diisocyanates and also their higher homologs that are obtainable by phosgenation of aniline-formaldehyde condensation products, 2,4- and 2,6-toluene diisocyanate and also their technical grade mixtures, triphenylmethane triisocyanates, alkylphenylene diisocyanates, xylylene diisocyanates, tetramethylxylylene diisocyanates, naphthalene 1,5-diisocyanate, biphenyl diisocyanates, triisocyanatotriphenyl thiophosphates. Also suitable are the conventional polyisocyanate-based products, for example, di- or trimerization products of the aforementioned isocyanates having a biuret, isocyanurate, uretidione, allophanate, and/or urethane structure.

Preferably the polyisocyanates (A) are isocyanate-functional prepolymers such as those obtainable in a conventional manner by reacting low or high molecular weight polyhydroxy compounds with excess amounts of polyisocyanate or else with a large excess of polyisocyanate and subsequent removal of the excess polyisocyanate, for example, by thin film distillation. Prepolymers are most preferably synthesized using aromatic polyisocyanates of the molecular weight range 150 to 300. Prepolymers are generally prepared at 40 to 140° C., optionally in the presence of conventional polyurethane chemistry catalysts, for example, organometallic compounds. Preference is given for example to tin(II) octoate, dibutyltin(II) diacetate, and dibutyltin(II) dilaurate. In addition, tertiary amines such as triethylamine or diazabicyclooctane may be used as catalysts.

Such prepolymers are usefully prepared using low molecular weight polyhydroxy compounds of the molecular weight range 60 to 300 g/mol, for example, ethylene glycol, 1,2-propylene glycol, 1,3-propylene glycol, 1,4-butanediol, 1,6-hexanediol, neopentylglycol, 2-ethyl-1,3-hexanediol, glycerol, trimethylolpropane, pentaerythritol, low molecular weight hydroxyl-containing esters of such polyols with dicarboxylic acids or low molecular weight ethoxylation or propoxylation products of such simple polyols, or any mixtures of such modified or unmodified alcohols. Preference is given in particular to NCO-prepolymers formed from toluene diisocyanate and trimethylolpropane.

Useful NCO-reactive compounds for component (B) that contain tert-amino groups include, for example:

(B1) monohydric alcohols containing at least one tert-amino group. Suitable examples are alkoxylated aliphatic, cycloaliphatic, aromatic, and heterocyclic secondary amines having an OH function, for example, N,N-dimethylethanolamine, N,N-diethyl ethanolamine, N,N-dibutylethanolamine, as well as N,N-dimethyl-isopropanolamine, N,N-dimethylpropanolamine, N-methyl-N-hydroxyethylaniline, N-methyl-N-hydroxypropylaniline, N-ethyl-N-hydroxyethylaniline, N-butyl-N-hydroxyethylaniline, N-hydroxyethylpiperidine, N-hydroxyethylmorpholine, and also their polyalkoxylated derivatives, the average molecular weight of polyalkoxylated products being 250 to 5000 glmol. Examples are polyalkoxylated N ,N-dimethylethanolamine, N,N-diethylethanolamine, and N,N-dibutylethanolamine and also polyalkoxylated N-hydroxyethylmorpholine.

(B2) Diols and higher alcohols containing at least one tert-amino group. Suitable examples are bisalkoxylated aliphatic, cycloaliphatic, aromatic, and heterocyclic primary amines having at least two OH functions and also trisalkoxylated ammonia, for example, N-methyl-diethanolamine, N-ethyidiethanolamine, N-butyldiethanolamine, N-lauryldiethanolamine, N-stearyldiethanolamine, N-oleyidiethanolamine, N-cyclohexyldiethanolamine, N-methyldiisopropanolamine, N-cyclohexyldiethanolamine, N-methyldiisopropanolamine, N-cyclohexyidiethanolamine, N,N-dihydroxyethylaniline, N,N-dihydroxy-ethyl-m-toluidine, N,N-dihydroxyethyl-p-toluidine, N,N-dihydroxypropylnaphthylamine, N,N′-dihydroxyethylpiperazine, tris[2-hydroxy-1-propylamine], N,N′-dimethyl-N,N′-bis-hydroxyethylhydrazine, and N,N′-dimethyl-N,N′-bishydroxypropylethylenediamine, amino-alcohols obtained, for example, by hydrogenation of addition products of alkylene oxide and acrylonitrile onto primary amines, for example, N-methyl-N-(3-aminopropyl)ethanolamine, N-cyclohexyl-N-(3-aminopropyl)-2-propanolamine, N,N-bis(3-aminopropyl)-ethanolamine, and N-(3-aminopropyl)diethanolamine, and also their polyalkoxylated derivatives, the number average molecular weight of the polyalkoxylated products being 250 to 5000 g/mol. Examples are polyalkoxylated N-methyldiethanolamine, N-ethyidiethanolamine, and N-butyidiethanolamine and also polyalkoxylated N,N′-dihydroxyethylpiperazine. Also useful are polyols containing tertiary amino groups that have not been obtained by alkoxylation of amines.

(B3) Further possible NCO-reactive compounds of component (B) that contain tertiary amino groups are amines without OH groups. Preferably these are aliphatic, cycloaliphatic, aromatic, or heterocyclic amines such as, for example, N,N-dimethylethylenediamine, 1-diethylamino-4-aminopentane, α-aminopyridine, 3-amino-N-ethylcarbazole, N,N-dimethylpropylenediamine, N-aminopropylpiperidine, N-aminopropylmorpholine, N-aminopropylethyleneimine and 1,3-bispiperidino-2-aminopropane, especially by hydrogenation of addition products of acrylonitrile onto primary and secondary amines, for example, bis(3-aminopropyl)methylamine, bis(3-aminopropyl)cyclohexylamine, bis(3-aminopropyl)aniline, bis(3-aminopropyl)toluidine, diaminocarbazole, bis(aminopropoxyethyl)butylamine, and tris(aminopropyl)amine.

In these NCO-reactive compounds, the amino groups may also be neutralized or quaternized by reaction with salt-forming compounds, such as inorganic and organic acids and also compounds having reactive halogen atoms and the esters of strong acids. The reaction can take place before or after the reaction of component (B) with component (A).

Useful neutralizing agents include, for example, hydrochloric acid, nitric acid, phosphoric acid, hypophosphorous acid, sulfuric acid, amidosulfonic acid, hydroxylamine monosulfonic acid, formic acid, acetic acid, glycolic acid, or lactic acid. Preference is given to using acetic acid or lactic acid.

Useful quaternizing agents include, for example, chloroacetic acid, ethyl chloroacetate, chloroacetamide, bromoacetic acid, ethyl bromoacetate, bromoacetamide, methyl chloride, ethyl chloride, propyl chloride, butyl chloride, benzyl chloride, ethylenechlorohydrin, methyl bromide, ethyl bromide, propyl bromides, butyl bromides, dibromomethane, ethylenebromohydrin, methyl iodide, dimethyl phosphite, dimethyl sulfate, diethyl sulfate, and methyl p-toluenesulfonate. Preference is given to using methyl chloride or dimethyl sulfate.

Useful NCO-reactive compounds (B) containing sulfonate groups include, for example, those obtainable by reaction of sulfo-containing NCO-reactive compounds with inorganic or organic bases as salt formers such as, for example, sodium hydroxide, potassium hydroxide, potassium carbonate, sodium bicarbonate, ammonia, and also primary, secondary, or tertiary amines. Salt formation can take place before or after reaction with the NCO groups of component (A).

Examples of sulfo-containing compounds are

(a) Hydroxy- and carboxysulfonic acids, such as 2-hydroxyethanesulfonic acid, phenol-2-sulfonic acid, phenol-3-sulfonic acid, phenol-4-sulfonic acid, phenol-2,4-disulfonic acid, sulfoacetic acid, 2-sulfobenzoic acid, 3-sulfobenzoic acid, 4-sulfobenzoic acid, 3,5-disulfobenzoic acid, 2-chloro-4-sulfobenzoic acid, 2-hydroxy-5-sulfobenzoic acid, 1-naphthol-4-sulfonic acid, 1-naphthol-5-sulfonic acid, 2-naphthol-8-sulfonic acid, 1-naphthol-2-sulfonic acid, 2-naphthol-6-sulfonic acid, 2-naphthol-7-sulfonic acid, 2-naphthol-6,8-disulfonic acid, 1-naphthol-4,8-disulfonic acid, 1-naphthol-4,7-disulfonic acid, 1-naphthol-3,8-disulfonic acid, 2-naphthol-3,6-disulfonic acid, 1-naphthol-3,6-disulfonic acid, chromotropic acid, or 3-hydroxy-6-sulfo-2-naphthoic acid.

(b) Aminosulfonic acids, such as amidosulfonic acid, hydroxylaminesulfonic acid, sulfanilic acid, N-phenylaminomethanesulfonic acid, 4,6-dichloroaniline-2-sulfonic acid, 1,3-phenylenediamine-4,6-disulfonic acid, 2-naphthylamine-1-sulfonic acid, 1-naphthylamine-4-sulfonic acid, 1-naphthylamine-5-sulfonic acid, 2-naphthylamine-6-sulfonic acid, 2-naphthylamine-8-sulfonic acid, 1-naphthylamine-8-sulfonic acid, 1-naphthylamine-3-sulfonic acid, 1-naphthylamine-6-sulfonic acid, 2-naphthylamine-6-sulfonic acid, 2-naphthylamine-7-sulfonic acid, 1-naphthylamine-7-sulfonic acid, 2-naphthylamine-5,7-disulfonic acid, 2-naphthylamine-6,8-disulfonic acid, 2-naphthyl-amine-4,8-disulfonic acid, 1-naphthylamine-4,8-disulfonic acid, 1-naphthylamine-4,7-disulfonic acid, 1-naphthylamine-3,8-disulfonic acid, 1 -naphthylamine-4,6-disulfonic acid, 1-naphthylamine-3,7-disulfonic acid, 1-naphthylamine-2,7-disulfonic acid, 2-naphthylamine-3,6-disulfonic acid, 1-naphthylamine-3,6-disulfonic acid, 1-naphthylamine-4,6,8-trisulfonic acid, 2-naphthylamine-3,6,8-trisulfonic acid, 1-naphthylamine-3,6,8-trisulfonic acid, 4,4′-di(p-aminobenzoylamine)diphenylurea-3,3′-disulfonic acid, phenylhydrazine-2,5-di-sulfonic acid, 2,3-dimethyl-4-aminoazobenzene-4′,5-disulfonic acid, 4′-aminostilbene-2,2′-disulfo-(4-azo-4)-anisole, carbazole-2,7-di-sulfonic acid, taurine, methyltaurine, butyltaurine, 3-amino-5-sulfobenzoic acid, 3-aminotoluene-N-methanesulfonic acid, 6-nitro-1,3-dimethylbenzene-4-sulfamic acid, 4,6-diaminobenzene-1,3-di-sulfonic acid, 2,4-diaminotoluene-5-sulfonic acid, 4,4′-diaminobiphenyl-2,2′-disulfonic acid, 2-aminophenol-4-sulfonic acid, 4,4′-oxydiaminobenzene-2-sulfonic acid, 2-aminoanisole-N-methane-sulfonic acid, 2-aminodiphenylaminesulfonic acid, 2-[4-(2-hydroxyethyl)piperazino]ethanesulfonic acid or 3-[4-(2-hydroxyethyl)piperazino]-1-propanesulfonic acid.

Also very useful are reaction products of 2-hydroxyethanesulfonic acid or their salts with polyamino compounds having 3 to 10 nitrogen atoms such as, for example, the sodium salt of aminoethyl-2-aminoethanesulfonic acid obtainable by reaction of sodium 2-hydroxyethanesulfonate with ethylenediamine.

Very useful compounds further include the salts of sulfurous acid, especially sodium hydrosulfite.

Particular preference is given to the class of the sulfonatediols; suitable compounds of this class are described, for example, in DE-A 24 46 440. Such compounds conform in general to the formula

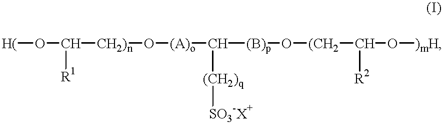

where

A and B represent identical or different divalent aliphatic hydrocarbon radicals of 1 to 6 carbon atoms,

R¹ and R² are independently hydrogen, an aliphatic hydrocarbon radical of 1 to 4 carbon atoms, or a phenyl radical,

X⁺ is an alkali metal cation or an optionally substituted ammonium group,

n and m are independently zero or from 1 to 30,

o and p are each zero or 1, and

q is zero, 1 or 2.

Preferred compounds of the formula (I) conform to the formulas

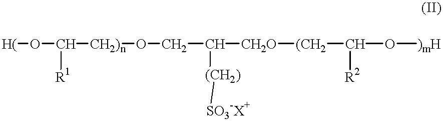

and

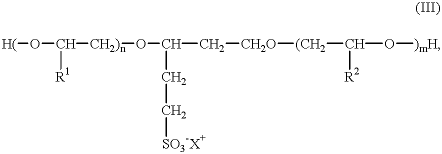

where

R¹ and R² are each independently hydrogen or methyl,

n and m are each independently zero or from I to 3, and

X⁺ is as defined in the formula (I).

Particular preference is given to sulfonatediols of the formula

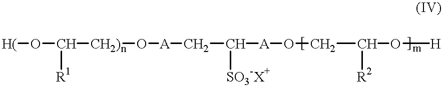

where

R¹ and R² are independently hydrogen or methyl,

A is a divalent aliphatic C₁-C₄-hydrocarbon radical, preferably methylene,

X⁺ is an alkali metal cation or an ammonium group, and n and m are an integer from 1 to 20.

Very particular preference is given to sulfonatediols of the formula (IV) where R¹ and R² are both CH₃.

Preferred cations X⁺ include potassium, sodium, and ammonium ions in which the ammonium nitrogen may be substituted by up to 4 organic C₁-C₁₀ radicals, although two such substituents may also be replaced by a divalent 4- or 5-membered radical that may optionally contain heteroatoms (such as oxygen, nitrogen, or sulfur) and that combine with the nitrogen atom belonging to X⁺ to form a heterocycle, for example, a morpholine or hexahydropyridine ring.

Component (B) is preferably used in such an amount that the blocked NCO-containing reaction products of the invention contain 1 to 100 milliequivalents of ionic groups per 100 g of blocked NCO reaction product.

When the products are used for applications where excessive hydrophilicity tends to be disadvantageous, the amount of ionic groups should tend to be at the low end of the defined range and preferably amount to 2 to 25 milliequivalents per 100 g of blocked polyisocyanate.

Useful NCO-reactive compounds other than (B), containing no sulfonate and/or tertiary amino groups, for component (C) include mono- or polyhydric (especially mono-, di-, or trihydric) polyether alcohols having a number average molecular weight of 500 to 10,000 g/mol. Useful components include, for example, poly-C₂-C₆-alkylene ethers, preferably poly-C₂-C₃-alkylene ethers, started on monols, diols, or triols. Useful starters further include mono- or polyacid amines.

Instead of the hydroxyl end group, the polyalkylene ethers may also bear amino or mercapto end groups, which may be prepared in a manner familiar to one skilled in the art.

Preferably, polyalkylene ether groups are 50 to 100% by weight ethylene oxide units and optionally further alkylene oxide units, especially propylene oxide units.

Particular preference is given to ethylene oxide/propylene oxide polyethers obtained by successive reaction of the starter molecule with ethylene oxide and propylene oxide (known as block polyethers). Another possibility is to react the starter with ethylene oxide/propylene oxide mixtures, in which case random polyethers are obtained. By combining the two possibilities it is also possible to obtain polyethers having ethylene oxide or propylene oxide blocks and mixed ethylene oxide/propylene oxide blocks.

It is also advantageous to use propylene oxide polyethers or propylene oxide polyetheramines (Jeffamines) as component (C). Appropriate reaction products containing blocked NCO groups lead to good hydrophobic and hand properties when treating textiles.

The blocked NCO-containing reaction products of the invention preferably contain, based on blocked NCO reaction product, 3 to 25% by weight of polyalkylene ether groups incorporated by polyether mono-alcohols, monoamines, or monomercaptans and reckoned as recurring alkyleneoxy groups (O-alkylene)ₓ.

Useful NCO-reactive compounds for component (C) further include chain extenders having a number average molecular weight of 30 to 499 g/mol. Mention may be made here of polyols or polyamines having preferably 2 to 8 (especially 2 or 3) hydroxyl and amino groups, respectively, per molecule. Preferred polyols include the following:

(i) alkanediols such as ethylene glycol, 1,3-propylene glycol, 1,2-propylene glycol, 1,4-butanediol, 1,5-pentanediol, 2,2-dimethyl-1,3-propanediol, and 1,6-hexanediol;

(ii) etherdiols, which in the case of polyalkylene ether diols preferably contain 1 to 4 recurring alkyleneoxy groups, such as diethylene glycol, triethylene glycol, or 1,4-phenylenebis(hydroxyethyl ether);

(iii) esterdiols of the formulas HO—(C₂-C₆-alkylene)-CO—O—(C₂-C₆-alkylene)-OH and HO—(C₂-C₆-alkylene)-O—CO—R—CO—O—(C₂-C₆-alkylene)-OH, where R is an alkylene or arylene radical of 1 to 10, preferably 2 to 6 carbon atoms, for example, δ-hydroxybutyl ε-hydroxycaproate, ω-hydroxyhexyl γ-hydroxybutyrate, bis(hydroxyethyl) ad ipate, bis(hydroxyethyl) terephthalate, and hydroxyneopentyl α-methyl-α-hydroxymethylpropionate.

Also suitable are more hydric alcohols such as glycerol, trimethylolethane, trimethylolpropane, trimethylolhexane, and also pentaerythritol.

Useful polyamines for component (C) are preferably aliphatic or aromatic diamines, for example, ethylenediamine, 1,2-propylenediamine, 1,3-propylenediamine, 1,4-tetramethylenediamine, 1,6-hexamethylenediamine, N,N′-diisobutyl-1,6-hexamethylenediamine, 1,11-undecamethylenediamine, 1,3-cyclohexanediamine, 1,4-cyclohexanediamine and also mixtures thereof, 1-amino-3,3,5-trimethyl-5-aminomethylcyclohexane, 2,4-and 2,6-hexahydrotoluenediamine and also mixtures thereof, perhydro-2,4′- and 4,4′-diaminodiphenylmethane and its 3,3′-dimethyl derivative and bis(3-aminopropyl)methylamine; p-xylylenediamine, bisanthranilic esters, 3,5- and 2,4-diarninobenzoic esters, diamines containing ester groups and also 3,3′-dichloro-4,4′-diaminodiphenylmethane, toluenediamine, 4,4′-diaminodiphenylmethane, and 4,4′-diaminodiphenyl disulfide. Diamines within this meaning also include hydrazine, hydrazine hydrate, and substituted hydrazines, for example, methylhydrazine, N,N′-dimethylhydrazine and homologs thereof and also acyl dihydrazides, for example, carbonohydrazide, oxalohydrazide, the dihydrazides of malonic acid, succinic acid, glutaric acid, adipic acid, β-methyladipic acid, sebacic acid, hydracrylic acid and terephthalic acid, semicarbazidoalkylene hydrazides, for example, β-semicarbazidopropionohydrazide, semicarbazidoalkylene carbazates, for example, 2-semicarbazidoethyl carbazate, or else aminosemicarbazide compounds, for example, β-aminoethyl semicarbazidocarbonate.

Further NCO-reactive compounds for component (C) are the customary polyurethane chemistry OH-, SH-, and/or NH-terminated polyesters or polycarbonates having a number average molecular weight of 500 to 100,000 g/mol, for example, simple polyesterdiols prepared by reaction of adipic acid, terephthalic acid or phthalic acid with excess amounts of alkanediols such as ethylene glycol, tetramethylene glycol, or hexamethylene glycol.

The NCO blocking agent is 1-H-pyrazole or its derivatives having the following general formula

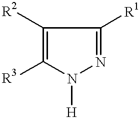

where

R¹, R², and R³ are identical or different and may be, for example, H, straight-chain or branched C₁-C₅-alkyl, C₅-C₁₂-cycloalkyl, aryl, arylalkyl, pyridinyl, halogen, —CN, —NO₂, C₁-C₅-alkyloxy, —CHO, —COOH, —CONH₂, —CONHNH₂, or C₁-C₅-alkyloxycarbonyl.

Furthermore, pyrazoles fused with (substituted) aromatic radicals-, for example, benzopyrazole, can be used as NCO blocking agents.

Preference is given to using methyl-substituted 1-H-pyrazoles such as, for example, 3-methylpyrazole, 5-methylpyrazole or 3,5-dimethylpyrazole as blocking agents for preparing the NCO-containing prepolymers.

Particular preference is given to 3,5-dimethylpyrazole-blocked NCO-containing prepolymers of

(A) aromatic polyisocyanates of toluene diisocyanate and trimethylolpropane,

(B) sulfonatediols, and

(C) ethylene oxide/propylene oxide polyethers.

The invention further provides a process for preparing the blocked NCO-containing reaction products of the invention comprising reacting the aromatic polyisocyanate (A) with component (B), the blocking agent 1-H-pyrazole or its derivative, and optionally (C) at one and the same time or in succession in any desired order. It is particularly preferable for components (A), (B), blocking agent, and optionally (C) to be mixed at room temperature and subsequently heated to the reaction temperature. Preference is here given to a reaction temperature between 50 and 120° C., especially 65-90° C.

Optionally, the reaction mixture may include conventional polyurethane chemistry catalysts, for example, organometallic compounds such as tin(II) octoate, dibutyltin(II) diacetate, or dibutyltin(II) dilaurate or tertiary amines such as triethylamine or diazabicyclooctane.

Although it is frequently of particular advantage not to use organic solvents at all, it will be appreciated that blocked polyisocyanates of the invention may also be prepared using organic solvents. When using highly viscous or solid blocked NCO-containing reaction products according to the invention, the use of organic solvents is generally advisable.

Preferred organic solvents include ketones such as acetone, methyl ethyl ketone, and cyclohexanone, ethers such as diethyl ether, dibutyl ether, tetrahydrofuran, and dioxane, ethers and/or esters of ethylene glycol and propylene glycol such as ethylene glycol monomethyl ether, ethylene glycol monoethyl ether, ethylene glycol monomethyl ether acetate, ethylene glycol monoethyl ether acetate, and propylene glycol diacetate, ethers and/or esters of di- or higher ethylene glycols or di- or higher propylene glycols, C₁-C₆-alkyl C₂-C₄-carboxylates such as ethyl acetate and butyl acetate, amides such as N,N-dimethylformamide, N,N-dimethylacetamide, and N-methylpyrrolidone, sulfolane, N-methylcaprolactam, benzine, aromatics such as benzene, toluene, and xylenes. The use of organic solvents containing NCO-reactive groups, for example, methanol, ethanol, n-propyl alcohol, or isopropyl alcohol, in the course of the preparation of the blocked polyisocyanates according to the invention is not advisable. The organic solvents, if desired, can be removed again, for example, by distillation, from the blocked NCO-containing reaction products of the invention.

The blocked NCO-containing reaction products of the invention are very useful for preparing aqueous dispersions and are also preferably used in that form. The level in these aqueous dispersions of blocked NCO-containing reaction products according to the invention can vary within wide limits and is generally 20 to 80% by weight, preferably 25 to 50% by weight. The blocked NCO-containing reaction products according to the invention can be dispersed by adding water to the blocked NCO reaction products or by introducing the blocked NCO reaction product into an initial charge of water.

The two phases are preferably combined by introducing energy into the mixture of the phases. This can be done for example by

(a) shaking, beating, stirring, or turbulent mixing,

(b) spraying one phase into the other,

(c) vibrations and cavitation in the mixture (ultrasound, for example),

(d) emulsifying centrifuges, or

(e) colloid mills and homogenizers.

The methods mentioned may also be combined. For instance, predispersion may be effected by stirring, followed by fine dispersion using homogenizers.

The dispersions are preferably prepared by adding water to the blocked NCO-containing reaction products by stirring.

Dispersion can be effected in the presence or absence of organic, preferably water-miscible, solvents. Useful organic solvents of this type include the above-mentioned solvents and additionally also compounds that can act as solvents and bear NCO-reactive groups, for example, alcohols such as methanol, ethanol, n-propyl alcohol, and isopropyl alcohol. The use of preferably water-miscible organic solvents is particularly preferable when the aqueous dispersion is to contain more than 50% by weight of blocked NCO reaction product according to the invention. For instance, after the last reaction step, the blocked NCO reaction product of the invention can be dissolved in a water-thinnable organic solvent such as isopropyl alcohol up to a level of 80 to 95% by weight of blocked NCO-containing reaction products according to the invention, based on the sum total of organic solvent and blocked NCO reaction product according to the invention. The organic solution obtained can then be further diluted with water.

The dispersion temperature is generally 10 to 100° C., preferably 30 to 80° C.

Dispersion of the blocked NCO-containing reaction products with water can be improved by customary emulsifiers or dispersants. Useful examples are alkylbenzenesulfonates, alkanesulfonates, olefinsulfonates, alkyl-arylpolyalkylene glycol ether sulfonates, ester sulfonates, sulfosuccinates, castor oil sulfonates, alkyl sulfates, alkylpolyalkylene glycol ether sulfates, alkyl-arylpolyalkylene glycol ether carboxylates, alkylaryl phosphates, alkylarylpolyalkylene glycol ether phosphates, glyceride sulfates, acylisethionates, acyltaurines, acylsarcosinates, alkylarylpolyalkylene glycol ethers, capped alkylarylpolyalkylene glycol ethers, phenolpolyalkylene glycol ethers, acylalkanolamidepolyalkylene glycol ethers, alkoxylated butynediol derivatives, acylpolyalkylene glycol esters, alkylaminepolyalkylene glycol ethers, ethylene oxide-propylene oxide block copolymers, alkylpolyglycosides, acylglucamides, ethoxylated sorbitan esters, quarternized alkylamines, alkylamine oxides, alkylbetaines, alkylamidobetaines, imidazolinium betaines, and sulfobetaines.

Useful dispersants include, for example, polyaspartic acids, n-alkylpolyaspartic acids, ligninsulfonates, carboxymethylcelluloses, hydroxyethylcelluloses, hydroxypropylcelluloses, modified starches, polyacrylic acids, maleic acid-acrylic acid copolymers, maleic acid-olefin copolymers, polyvinyl alcohol, polyvinylpyrrolidone, vinylpyrrolidone-vinylacetate copolymers, vinylpyrrolidone-vinylimidazole copolymers, vinylpyrrolidoneacrylate copolymers, and vinylpyrrolidone-vinylcaprolactam copolymers.

Alkylpolyalkylene glycol ethers as obtained by reaction of fatty alcohols with ethylene oxide are particularly useful.

The compounds described as chain extenders can be added either before or, especially in the case of amino-containing substances, after the dispersion of the blocked polyisocyanates in water.

The aqueous dispersions obtained generally contain the blocked NCO-containing reaction products of the invention as particles having an average diameter of 50 to 2000 nm, preferably 80 to 300 nm.

The blocked NCO-containing reaction products of the invention are useful, preferably in the form of their aqueous dispersions, for treating textiles, paper, or leather, for example.

The invention therefore likewise provides preparations containing

(a) blocked NCO-containing reaction product according to the invention and

(b) at least one emulsifier and/or dispersant.

In a preferred embodiment, the amount of (b) in the preparation is 1 to 10% by weight, based on the blocked NCO reaction product according to the invention. It is particularly preferable for the preparation to be in the form of an aqueous dispersion containing 5 to 50% by weight, based on the preparation, for the total amount of (a) and (b).

In this connection, they are useful, for example, in combination with fluorinated organic compounds for imparting hydrophobic/oleophobic and antistain properties to textiles. Modern textile materials used, for example, as cover fabrics, awnings, or textile floorcovering are expected by the consumer to have favorable properties with regard to mechanical durability, i.e., their static and dynamic strength, and imperviousness to water, oil, and/or soil.

Soiling substances can be, for example, of the following composition and consistency: oil and oily substances, liquid, aqueous colored substances, inorganic dry pigmentary substances (road dust, for example), aqueous suspensions thereof, and mixtures thereof.

The idea of a protective finish is that the finish confers on the textiles hydrophobic and oleophobic properties that prevent the absorption of liquid soils. Dry soil does not adhere to the fibers and is easily removable, for example, by vacuum cleaning.

A further property frequently required of textiles, especially for use outdoors, is the ability to provide water resistance coupled with high wear comfort.

An important class of such hydrophobicizing and/or oleophobicizing agents for textile finishes are perfluorinated organic compounds, which are usually used in the form of polymer dispersions. It has now been determined that compositions containing such fluorinated hydrophobicizing/oleophobicizing agents and blocked NCO-containing reaction products according to the invention surprisingly confer a desirable combination of outstanding properties on textiles finished with these compositions. More particularly, the laundering resistance of the finish has been pleasingly improved over the prior art. Moreover, the products of the invention are less prone to yellowing.

A further possible use for the products of the invention is the wrinkleproofing of textile materials composed of natural or regenerated cellulose (cotton, viscose).

Textiles made of cellulosic fibers such as cotton have the advantage over synthetic fibers of being hydrophilic, which manifests itself in high moisture absorption and good wear comfort. The reason for the high moisture absorption is the swellable amorphous regions in cellulosic fiber. However, cellulose swollen by washing or perspiration wrinkles and has to be smoothed again by thermal and mechanical treatment. In addition, cotton shrinks on washing, causing textiles to lose their original shape. To control these disadvantages, cellulosic fibers have for many years been treated with products that, by reacting with the hydroxyl groups of the cellulose, partly crosslink the amorphous parts of the fiber. Preferred crosslinkers are methylolated urea or melamine derivatives. The disadvantage for these compounds is that they may release formaldehyde in the course of the finishing and use of the textile.

The use of blocked or unblocked polyisocyanates as wrinkle-proofers has already been considered. But the use of these products to date is limited because of insufficient liquor stability, a high crosslinking temperature or poor finishing parameters such as wrinkling and shrinkage values, hand, or tendency to yellow.

It has been determined that the blocked polyisocyanates of the invention overcome the disadvantages of the prior art.

Wrinkleproofing consumes relatively large amounts of crosslinker to obtain the desired effects. Since the products of the invention have little if any tendency to yellow, they are particularly advantageous for use on whites.

To finish textiles, they are treated with an aqueous liquor that contains the products of the invention as a crosslinker. The blocked polyisocyanates are customarily used in this context in concentrations of 5 to 100 g/l, preferably 10 to 50 g/l.

The liquors may further include customary textile industry products, for example, softeners, antistats, antislip agents, hand variators, hydrophobicizers, oleophobicizers, flame retardants, defoamers, brighteners, biocides, and also pH regulators. The use of the blocked polyisocyanates according to the invention also improves the laundering durability of the products described. If desired, the products of the invention may also be used in combination with customary crosslinkers such as methylolated urea or melamine derivatives.

The treatment of the textile material with the liquor may be effected by methods familiar to one skilled in the art, such as slop padding, spraying, face padding, or foaming. The textile is subsequently dried at temperatures of customarily 100 to 120° C., typically to a residual moisture content of 2 to 20% depending on the type of fiber used. This is followed by a heat treatment at temperatures of 120 to 220° C., preferably 130 to 180° C. The drying and heat treatment steps may also be carried out in one operation.

Furthermore, the blocked polyisocyanates may be used as crosslinkers in textile printing. The textile printing industry crosslinks mixtures of binder and pigment using reactive compounds, for example, formaldehydic melamine derivatives. The disadvantage of this is that formaldehyde can be released in the course of the crosslinking of the print paste and by the printed textile.

Polyisocyanate compounds have therefore been developed as nonformaldehydic crosslinkers. But these products have the disadvantage of either lacking adequate stability in the print pastes or crosslinking only at high temperatures.

The products of the invention not only possess good stability in the print paste but also have a lower deblocking temperature.

A further possible use is for the antifelt finishing of wool. Untreated wool tends to felt on wearing and cleaning. The reason for this is essentially the scale structure of wool, which causes individual fibers to become tangled with each other. The felting tendency of wool can be substantially reduced by removing the scales by chemical or physical processes or masking them with polymers. Frequently, moreover, the two possibilities are also combined with each other.

Isocyanates or isocyanate prepolymers are very useful as polymers or polymer-forming compounds for the antifelt finishing of wool. For instance, WO-A-99/10590 and the references cited therein describe unblocked isocyanates for this application. These isocyanates can either be used in organic solvents or applied from aqueous liquors. Since isocyanates react with water, however, the liquors only have a limited use life. Moreover, the hydrophilicization of the isocyanates which is necessary for dispersion in water usually leads to reduced laundering and cleaning stability on the part of the finish.

DE-A-23 07 563 and DE-A-24 39 056 utilize bisulfite-blocked isocyanate prepolymers for the antifelt finishing of wool. But these products have the disadvantage that sulfur dioxide is released on use. Other common blocking agents have excessively high deblocking temperatures, at which the thermally sensitive wool would be damaged.

The products of this invention do not have these disadvantages. They possess excellent stability in water as well as high reactivity.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all percentages are percentages by weight.

### EXAMPLES

I. Starting Compounds Used:

Aromatic polyisocyanate 1:

Obtainable by reaction of trimethylolpropane with excess toluene diisocyanate and subsequent distillative removal of the excess toluene diisocyanate, as a 75% solution in ethyl acetate, NCO content: 13.2% by weight, for example, Desmodur® L 75 (Bayer AG).

Polyether 1:

Monofunctional ethylene oxide/propylene oxide polyether started on n-butanol (EO:PO weight ratio=85:15), having an average molecular weight of 2250 g/mol and an OH number of 25.

Polyether 2:

Difunctional propylene oxide polyether started on propylene glycol, having an average molecular weight of 2000 g/mol and an OH number of 56.

Emulsifier 1:

Fatty alcohol polyglycol ether obtainable by addition of 10 mol of ethylene oxide onto technical grade Lorol® (Cognis).

Polyether sulfonate

Product obtainable by reaction of 2-butene-1,4-diol with propylene oxide and addition of sodium hydrogensulfite and having an average molecular weight of 430 g/mol.

AAS solution

Sodium salt of aminoethyl-2-aminoethanesulfonic acid (45% in water).

Catalyst

Dibutyltin dilaurate, for example, Desmorapid® Z (Bayer AG)

II. Preparation of blocked Polyisocyanates

### Example 1

To 137.9 g (0.4334 eq) of the aromatic polyisocyanate 1 were added with stirring in succession 23.3 g of ethyl acetate, 21.3 g (0.0095 eq) of polyether 1, 6.1 g (0.0284 eq) of polyether sulfonate, 38.1 g (0.3963 eq) of 3,5-dimethylpyrazole, and 0.015 g of catalyst. After heating to 85° C. stirring was continued at 85° C. for 3 hours until the NCO band in the IR spectrum had disappeared. The batch was cooled to 50° C., and 395 g of demineralized water were added dropwise over 10 minutes. The ethyl acetate solvent was subsequently distilled off under reduced pressure. This afforded a dispersion having the following characteristic data:

| Average particle size: | 0.18 μm |
|---|---|
| Solids content: | 30% |
| —SO₃Na/100 g: | 2.52 meq |
| Blocked NCO/100 g: | 2.95% |

### Example 2

To 137.9 g (0.4334 eq) of the aromatic polyisocyanate 1 were added with stirring in succession 23.3 g of ethyl acetate, 21.3 g (0.0095 eq) of polyether 1,17.5 g (0.0175 eq) of polyether 2, 6.1 g (0.0284 eq) of polyether sulfonate, 36.5 g (0.3797 eq) of 3,5-dimethylpyrazole, and 0.015 g of catalyst. After heating to 85° C. stirring was continued at 85° C. for 3 hours until the NCO band in the IR spectrum had disappeared. The batch was cooled to 50° C., and 430 g of demineralized water were added dropwise over 10 minutes. The ethyl acetate solvent was subsequently distilled off under reduced pressure. This afforded a dispersion having the following characteristic data:

| Average particle size: | 0.15 μm |
|---|---|
| Solids content: | 30% |
| —SO₃Na/100 g: | 2.31 meq |
| Blocked NCO/100 g: | 2.59% |

### Example 3

To 137.9 g (0.4334 eq) of the aromatic polyisocyanate 1 were added with stirring in succession 23.3 g of ethyl acetate, 21.3 g (0.0095 eq) of polyether 1,17.5 g (0.0175 eq) of polyether 2, 36.5 g (0.3797 eq) of 3,5-dimethylpyrazole, and 0.015 g of catalyst. After heating to 85° C. stirring was continued at 85° C. for 3 hours, the batch was cooled to 50° C. and 5.9 g (0.0279 eq) of AAS solution were added. Following a supplementary stirring time of 10 minutes, the NCO band was no longer detectable in the IR spectrum. 420 g of demineralized water were added dropwise over 10 minutes with stirring. The ethyl acetate solvent was subsequently distilled off under reduced pressure. This afforded a dispersion having the following characteristic data:

| Average particle size: | 0.16 μm |
|---|---|
| Solids content: | 30% |
| —SO₃Na/100 g: | 2.31 meq |
| Blocked NCO/100 g: | 2.64% |

### Example 4

To 137.9 g (0.4334 eq) of the aromatic polyisocyanate 1 were added with stirring in succession 23.3 g of ethyl acetate, 17.5 g (0.0175 eq) of polyether 2, 6.1 g (0.0284 eq) of polyether sulfonate, 37.3 g (0.3880 eq) of 3,5-dimethylpyrazole, and 0.015 g of catalyst. After heating to 85° C. stirring was continued at 85° C. for 3 hours until the NCO band in the IR spectrum had disappeared. The batch was cooled to 50° C., 21.3 g of emulsifier 1 and 433 g of demineralized water were added dropwise over 10 minutes. The ethyl acetate solvent was subsequently distilled off under reduced pressure. This afforded a dispersion having the following characteristic data:

| Average particle size: | 0.14 μm |
|---|---|
| Solids content: | 30% |
| —SO₃Na/100 g: | 2.29 meq |
| Blocked NCO/100 g: | 2.63% |

### Example 5

To 137.9 g (0.4334 eq) of the aromatic polyisocyanate 1 were added with stirring in succession 23.3 g of ethyl acetate, 17.5 g (0.0175 eq) of polyether 2,21.4 g (0.0995 eq) of polyether sulfonate, 30.4 g (0.3162 eq) of 3,5-dimethylpyrazole, and 0.015 g of catalyst. After heating to 85° C. stirring was continued at 85° C. for 3 hours until the NCO band in the IR spectrum had disappeared. The batch was cooled to 50° C., and 452 g of demineralized water were added dropwise over 10 minutes. The ethyl acetate solvent was subsequently distilled off under reduced pressure. This afforded a dispersion having the following characteristic data:

| Average particle size: | 0.11 μm |
|---|---|
| Solids content: | 30% |
| —SO₃Na/100 g: | 7.70 meq |
| Blocked NCO/100 g: | 2.06% |

### Example 6

To 137.9 g (0.4334 eq) of the aromatic polyisocyanate 1 were added with stirring in succession 23.3 g of ethyl acetate, 17.5 g (0.0175 eq) of polyether 2, 34.5 g (0.3589 eq) of 3,5-dimethylpyrazole, and 0.015 g of catalyst. After heating to 85° C. stirring was continued at 85° C. for 3 hours; 3.4 g (0.0571 eq) of diethanolmethylamine were added and stirring was continued for a further hour until the NCO band was no longer detectable in the IR spectrum. The batch was cooled to 50° C., 3.6 g (0.029 mol) of dimethyl sulfate were added and stirring was continued for a further 2 hours, at which point 21.3 g of emulsifier 1 were added, followed by 429 g of demineralized water added dropwise over 10 minutes. The ethyl acetate solvent was subsequently distilled off under reduced pressure. This afforded a dispersion having the following characteristic data:

| Average particle size: | 0.20 μm |
|---|---|
| Solids content: | 30% |
| N⁺/100 g: | 4.66 meq |
| Blocked NCO/100 g: | 2.46% |

### Example 7

To 137.9 g (0.4334 eq) of the aromatic polyisocyanate 1 were added with stirring in succession 23.3 g of ethyl acetate, 17.5 g (0.0175 eq) of polyether 2, 37.3 g (0.3880 eq) of 3,5-dimethylpyrazole, and 0.015 g of catalyst. After heating to 85° C. stirring was continued at 85° C. for 3 hours; 3.4 g (0.0571 eq) of diethanolmethylamine were added and stirring was continued for a further hour until the NCO band was no longer detectable in the IR spectrum. The batch was cooled to 50° C., 2.56 g (0.028 mol) of lactic acid and 21.3 g of emulsifier 1 were added, followed by 426 g of demineralized water added dropwise over 10 minutes. The ethyl acetate solvent was subsequently distilled off under reduced pressure. This afforded a dispersion having the following characteristic data:

| Average particle size: | 0.23 μm |
|---|---|
| Solids content: | 30% |
| N⁺/100 g: | 4.69 meq |
| Blocked NCO/100 g: | 2.48% |

III. Use of Blocked Polyisocyanate Dispersions for Hydrophobic/Oleophobic Finishing of Textiles

To demonstrate the outstanding effectiveness of the products according to the invention, the product of Example 1 (hereinafter referred to as finish 1) was used in combination with further components for the hydrophobic/oleophobic finishing of various fabrics. The further components used were additionally the following products:

DMDHEU: 55% aqueous solution of dimethyloldihydroxylethyleneurea

Baygard® AFF: Fluoroalkyl acrylate copolymer (Bayer AG).

For comparison, a butanone oxime blocked isocyanate was used; it corresponds to Example 1 (cf. Example 2 of EP-A 537,578) except for the blocking agent hereinbelow referred to as finish 2.

The quality of the finish was determined by the following methods:

1. Determination of the water-propellant properties of sheetlike structures by the Bundesmann (EN 29865) shower test using the following parameters:

Bead-off time [min]

Bead-off effect (rated on a scale from 5 to 1)

Water absorption [%]

2. Oil resistance to AATCC 118-1997 (rated on a scale from 8 to 1)

3. Spray test to AATCC 22-1996 (rated on a scale from 100 to 0)

4. CIE whiteness

5. The laundering durability of the finish is determined by washing the samples according to EN 26330, Method 5 A and drying them according to Method E (tumble dryer).

### Use Example 1

### PES/CO Test Fabric

An approximately 160 g/m² fabric woven from 67/33 PES/CO blend yarn was impregnated with the liquors recited in the table, squeezed off on a pad-mangle to a wet pick-up of about 70%, dried at 110° C., and subsequently cured at 150° C. for 5 minutes.

Composition of Liquor in g/l:

| Finish | 1 | 2 |
|---|---|---|
| Acetic acid 60% | 1 | 1 |
| DMDHEU (about | 40 | 40 |
| 55%) | | |
| Zinc nitrate | 3 | 3 |
| Baygard AFF | 50 | 50 |
| Product of Ex. 1 | 15 | |
| Comparative | | 15 |
| product | | |

| | |
|---|---|
| | Measurements after |
| Measurements after finishing | 3 washes/dryer |

| Finish | 1 | 2 | 1 | 2 |
|---|---|---|---|---|
| Time [min] | 10 | 10 | 10 | 10 |
| Rating | 6 | 5 | 5 | 5 |
| Water absorption [%] | 2.1 | 4.1 | 11.9 | 15.6 |
| Oil rating | 6 | 5 | 5 | 4 |
| Spraytest | 100 | 100 | 100 | 100 |
| CIE whiteness | 138.2 | 135.9 | 138.0 | 134.7 |

### Use Example 2

### Polyamide PA Test Fabric

An approximately 150 g/m² fabric woven from polyamide was impregnated with the liquors recited in the table, squeezed off on a pad-mangle to a wet pick-up of about 55%, dried at 110° C., and subsequently cured at 150° C. for 5 minutes.

Composition of Liquor in g/l:

| Finish | 1 | 2 |
|---|---|---|
| Acetic acid 60% | 1 | 1 |
| Baygard AFF | 40 | 40 |
| Product of Ex. 1 | 8 | |
| Comparative | | 8 |
| product | | |

| | |
|---|---|
| | Measurements |
| | after 3 |
| Measurements after finishing | washes/dryer |

| Finish | 1 | 2 | 1 | 2 |
|---|---|---|---|---|
| Time [min] | 10 | 10 | 10 | 10 |
| Rating | 4 | 4 | 4 | 4 |
| Water absorption [%] | 1.2 | 3.1 | 5.7 | 6.7 |
| Oil rating | 4 | 3 | 3 | 2 |
| Spray test | 100 | 100 | 100 | 100 |

### Use Example 3

### PES Test Fabric

An approximately 150 g/m² fabric woven from PES is was impregnated with the liquor according to Use Example 2, squeezed off on a pad-mangle to a wet pick-up of about 60%, dried at 110° C., and subsequently cured at 150° C. for 5 minutes.

| | |
|---|---|
| | Measurements |
| | after 3 |
| Measurements after finishing | washes/dryer |

| Finish | 1 | 2 | 1 | 2 |
|---|---|---|---|---|
| Time [min] | 10 | 10 | 10 | 10 |
| Rating | 5 | 5 | 5 | 5 |
| Water absorption [%] | 0 | 0 | 0 | 0 |
| Oil rating | 6 | 6 | 6 | 5 |
| Spray test | 100 | 100 | 100 | 100 |

Results of Hydrophobic/Oleophobic Finishing on Textiles:

The polyisocyanate dispersions according to the invention had substantially improved properties over the prior art.

Whiteness was pleasingly improved compared with prior art products.

The products of the invention also provided improved hydrophobic or oleophobic performance on various fabrics. As a result, the amount of perfluorinated compounds needed to obtain hydrophobic or oleophobic effects can be reduced.

IV. Use Examples of Blocked Polyisocyanate Dispersions

Wrinkle- and shrinkage-proofing of textiles

Cotton (100% cotton having a basis weight of 110 g/m²) was initially dipped into the finishing liquors and subsequently squeezed off on a pad-mangle to a wet pick-up of 70-85%. The textile thus treated was put on a stenter and dried at 120° C. for 10 minutes and cured at 140° C. for 5 minutes. An untreated sample was used for comparison (finish 0).

The samples were then rated for DIN 53890 crease recovery angle, DIN 53892 dimensional change, and DIN 53895 post-wash self-smoothing performance. To determine the dimensional change and the self-smoothing performance, the samples were washed according to DIN 53920 Method 3 A.

The product of Example 1 according to the invention was a constituent of finishing liquor 1.

For comparison, Example 2 of EP 0537578 was repeated (finish 2) and a commercially available formaldehydic crosslinker (DMDHEU, 55% aqueous solution of dimethyloldihydroxylethyleneurea, finish 3) was used.

Composition of Finishing Liquor 1 in g/l:

| Finish | 1 | 2 | 3 |
|---|---|---|---|
| Product Ex. 1 | 130 | | |
| Comparative product | | 130 | |
| Acetic acid 60% | | | 1 |
| DMDHEU | | | 60 |
| MgCl₂ | | | 15 |

Measurements After Finishing

| Finish | 1 | 2 | 3 | 0 |
|---|---|---|---|---|
| Crease recovery angle W + F to | 132 | 135 | 133 | 87 |
| DIN 53890 | | | | |
| Dimensional change W + F to | −1.0 | −1.1 | −1.1 | −3.1 |
| DIN 53892 in % | | | | |
| Self-smoothing rating to | 3.4 | 3.2 | 3.2 | 1 |
| DIN 53895 | | | | |
| CIE whiteness | 141.1 | 139.9 | 137.7 | 142.1 |

The examples show that the products of the invention are very useful for wrinkle- and shrinkage-proofing textiles. Improved whiteness over the prior art is a surprise.

V. Use Examples of Blocked Polyisocyanate Dispersions as Crosslinkers in Textile Printing

The blocked polyisocyanate dispersion of Example 1 was used as a crosslinker in textile printing (print paste 1).

For comparison, crosslinker 3 of DE-A-4433437 was reproduced (print paste 2).

Products Used:

Acraconz® BN: Synthetic thickener based on acrylate (Bayer AG)

Emulgator VA: Dispersant based on polyurethane polyethylene glycol (Bayer AG)

Emulgator® WN: Emulsifier and dispersant, arylpolyglycol ether (Bayer AG)

Respumit 3300: Defoamer based on mineral oil (Bayer AG)

Acramin® Marineblau FBC 150%: Pigment based on Cu phthalocyanine (Bayer AG)

Acramin® ALW: Dispersion binder based on acrylate/acrylonitrile (Bayer AG)

The printing substrate used was 50:50 PES-CO. Drying at 120° C. was followed by fixing at 1 50° C. for 8 minutes.

Composition of Print Pastes in g/l:

| | 1 | 2 |
|---|---|---|
| Acraconz ® BN | 34 | 34 |
| Emulgator VA/WN 1:1 | 3 | 3 |
| Respumit ® 3300 | 4 | 4 |
| Acramin ® Marineblau | 40 | 40 |
| FBC 150% | | |
| Acramin ® ALW | 120 | 120 |
| Product of Ex. 1 | 14 | |
| Comparative product | | 14 |

The quality of the pigment print using the crosslinker according to the invention exhibited substantially better properties compared with the prior art with regard to brush washing, dry rubfastness and wet rubfastness.

VI. Use Examples of Blocked Polyisocyanate Dispersions for Antifelt Finishing of Wool

A plasma-treated wool slubbing (cf. DE 19 616 776) was treated with a finishing liquor, squeezed off on a pad-mangle, dried at 80° C. for 20 minutes, and subsequently cured at 140° C. for 1.5 minutes.

A butanone oxime-blocked crosslinker 3 of DE-A-44 33 437 is used for comparison (finish 2).

Composition of Finishing Liquor in g/l:

| Finish | 1 | 2 |
|---|---|---|
| Acetic acid 60% | 1 | 1 |
| Product of Ex. 1 | 60 | |
| Comparative product | | 60 |

The quality of the antifelt treatment was determined by the Aachen felting ball test of IWTO 20-69. For this test, a sample was exposed to mechanical felt-forming conditions for a defined period (1 h in all examples). The fewer the number of individual wool fibers that become tangled with each other, the larger the remaining size of the ball tested. The treated wool can be classified as nonfelting when the ball diameter is larger than 3.4 cm after the test.

Measurements After Finishing (Averages of Two Measurements)

| Finish | 1 | 2 |
|---|---|---|
| Felting ball diameter [cm] | 3.467 | 3.193 |

The examples show that the product of the invention is very useful for the antifelt finishing of wool.

What is claimed is:

1. An NCO-containing reaction product blocked at the NCO groups by 1-H-pyrazole or a derivative thereof, wherein the NCO-containing reaction product is a reaction product of
(A) one or more aromatic polyisocyanates,
(B) one or more NCO-reactive compounds containing sulfonate and/or tert-amino groups, and
(C) optionally, one or more further NCO-reactive compounds other than compounds (B).

2. A blocked NCO-containing reaction product according to claim 1 wherein the aromatic polyisocyanate (A) has an average molecular weight of 500 to 5000 g/mol.

3. A blocked NCO-containing reaction product according to claim 1 wherein the aromatic polyisocyanate (A) has an NCO content of 8-20% by weight.

4. A blocked NCO-containing reaction product according to claim 1 wherein the reaction product is blocked at the NCO groups with a dimethylpyrazole derivative.

5. A blocked NCO-containing reaction product according to claim 4 wherein the reaction product is blocked at the NCO groups with 3,5-dimethylpyrazole.

6. A blocked NCO-containing reaction product according to claim 1 wherein the NCO-reactive compound (B) possesses sulfonate groups.

7. A blocked NCO-containing reaction product according to claim 1 wherein further NCO-reactive compounds (C) are present and are compounds containing polyoxyalkylene groups.

8. A process for preparing a blocked NCO-containing reaction products according to claim 1 comprising reacting components (A), (B), and optionally (C) and 1-H-pyrazole or a derivative thereof as a blocking agent with each other at one and the same time or in any desired order.

9. A preparation comprising
(a) a blocked NCO-containing reaction product according to claim 1, and
(b) at least one emulsifier and/or dispersant.

10. A method for treating textiles, paper, or leather comprising applying a blocked NCO-containing reaction product according to claim 1 to a textile, paper, or leather.

11. A method for imparting hydrophobic/oleophobic or antistain properties to textiles comprising applying a blocked NCO-containing reaction product according to claim 1 in combination with a fluorinated organic compound to a textile.

12. A method for imparting hydrophobic/oleophobic or antistain properties to textiles comprising applying a blocked NCO-containing reaction product according to claim 1 in combination with a hydroxyl-free fluorinated organic compound to a textile.

13. A method for treating textiles to reduce the wrinkling and shrinking of the treated textiles comprising applying a blocked NCO-containing reaction product according to claim 1 to a textile.

14. A method for textile printing comprising applying to a textile a printing paste containing a blocked NCO-containing reaction product according to claim 1 as a crosslinker.

15. A method for antifelt finishing of wool or wool blends comprising applying a blocked NCO-containing reaction product according to claim 1 to wool or a wool blend.
